(19) United States
(12) Patent Application Publication
(10) Pub. No.: US 2020/0127888 A1
(43) Pub. Date: Apr. 23, 2020

(54) MOVABLE OBJECT

(71) Applicant: TOYOTA JIDOSHA KABUSHIKI KAISHA, Toyota-shi (JP)

(72) Inventors: Tae SUGIMURA, Miyoshi-shi (JP); Hirotaka KARUBE, Toyota-shi (JP); Kazuki MATSUMOTO, Ohgaki-shi (JP); Makoto MORI, Nagakute-shi (JP); Jun KONDO, Nissin-shi (JP)

(73) Assignee: TOYOTA JIDOSHA KABUSHIKI KAISHA, Toyota-shi (JP)

(21) Appl. No.: 16/583,531

(22) Filed: Sep. 26, 2019

(30) Foreign Application Priority Data
Oct. 18, 2018 (JP) 2018-196502

(51) Int. Cl. H04L 12/24; H04W 64/00; H04B 7/155

(52) U.S. Cl. CPC H04L 41/0677; H04W 88/08; H04B 7/155; H04W 64/00

(57) ABSTRACT

A movable object according to one aspect of the disclosure is a movable object including a drive unit and a communication device, and includes: a determination section that determines failure of a base station via the communication device; a movement control section that drives the drive unit to cause movement of the movable object to a specified relay location on a route connecting a first location included in a first cell of a first base station and a second location included in a second cell of a second base station; and a relay processing section that relays a signal at the specified relay location, the signal being exchanged between a wireless communication terminal located in the first cell and the second base station.

### INCORPORATION BY REFERENCE

The disclosure of Japanese Patent Application No. 2018-196502 filed on Oct. 18, 2018 including the specification, drawings and abstract is incorporated herein by reference in its entirety.

### BACKGROUND

### 1. Technical Field

The disclosure relates to a movable object.

### 2. Description of Related Art

In Japanese Patent Application Publication No. 2017-28334 (JP 2017-28334 A), a wireless communication system is disclosed in which a base station with increased traffic and a base station without the increased traffic prioritize packets transmitted through the base station with the increased traffic in occurrence of a disaster.

### SUMMARY

However, the wireless communication system disclosed in JP 2017-28334 A cannot provide means of solving a problematic case where failure occurs to the base station, which prohibits such a base station from making wireless communication with a communication terminal in a cell.

In view of the above, the disclosure has a purpose of providing a movable object capable of communicably connecting a wireless communication terminal in a cell of a failed base station to another base station even in the case where the base station fails.

A movable object according to one aspect of the disclosure is a movable object including a drive unit and a communication device, and includes: a determination section that determines failure of a base station via the communication device; a movement control section that drives the drive unit to cause movement of the movable object to a specified relay location on a route connecting a first location included in a first cell of a first base station and a second location included in a second cell of a second base station; and a relay processing section that relays a signal at the specified relay location, the signal being exchanged between a wireless communication terminal located in the first cell and the second base station.

The disclosure can provide the movable object capable of communicably connecting the wireless communication terminal in the cell of the failed base station to another base station even in the case where the base station fails.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a view of a schematic configuration of a wireless communication system 100 according to an embodiment of the disclosure;

FIG. 2 is a perspective view of a schematic configuration of a movable object 1 according to the embodiment of the disclosure;

FIG. 3 is a block diagram of a schematic system configuration of the movable object 1 according to the embodiment of the disclosure;

FIG. 4 is a schematic block diagram for illustrating each function module provided in a controller 9 according to the embodiment of the disclosure;

FIG. 5 is a chart of an example of an operation sequence in relay processing that is executed by the wireless communication system 100 according to the embodiment of the disclosure;

FIG. 6 is a view of an example of operation in the relay processing that is executed by the wireless communication system 100 according to the embodiment of the disclosure;

FIG. 7 is a view of an example of the operation in the relay processing that is executed by the wireless communication system 100 according to the embodiment of the disclosure;

FIG. 8 is a view of an example of the operation in the relay processing that is executed by the wireless communication system 100 according to the embodiment of the disclosure;

FIG. 9 is a view of an example of the operation in the relay processing that is executed by the wireless communication system 100 according to the embodiment of the disclosure; and

FIG. 10 is a view of an example of the operation in the relay processing that is executed by the wireless communication system 100 according to the embodiment of the disclosure.

### DETAILED DESCRIPTION OF EMBODIMENTS

A preferred embodiment of the disclosure will be described with reference to the accompanying drawings. In the drawings, members denoted by the same reference numerals and symbols have the same or similar configurations.

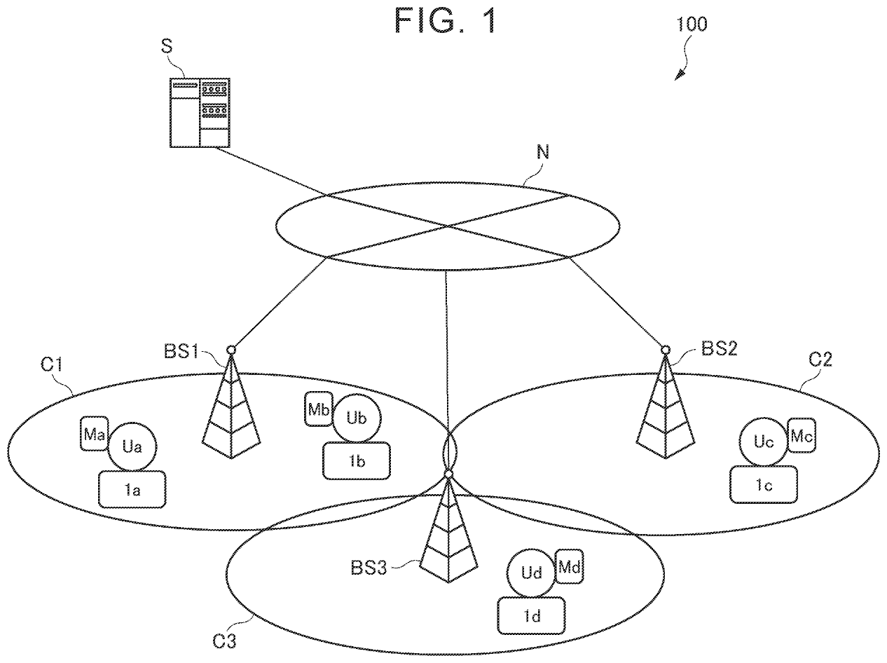

FIG. 1 is a view of a schematic configuration of a wireless communication system 100 according to an embodiment of the disclosure.

The wireless communication system 100 includes movable objects 1, a wireless communication terminals M, base stations BS, and a server S. The server S is a server used by a service provider, for example, and manages various types of information on the movable objects 1. Each of the base stations BS and the server S are communicably connected to each other via a network N. Each of the base stations BS has a cell C as a region where communication can be made with the corresponding base station BS by a specified wireless communication standard. The movable object 1 and the wireless communication terminal M located within the cell C can communicate with the base station BS corresponding to the cell C by the specified wireless communication standard.

In FIG. 1, as examples of the base stations BS, base stations BS1, BS2, BS3 are illustrated, and the base stations BS1, BS2, BS3 have cells C1, C2, C3, respectively. In addition, FIG. 1 illustrates, as examples of the movable objects 1, movable objects 1a, 1b, 1c, 1d. Furthermore, FIG. 1 illustrates users of the movable objects 1a, 1b, 1c, 1d as users Ua, Ub, Uc, Ud. Moreover, FIG. 1 illustrates, as examples of the wireless communication terminals M, wireless communication terminals Ma, Mb, Mc, Md used by the users Ua, Ub, Uc, Ud, respectively.

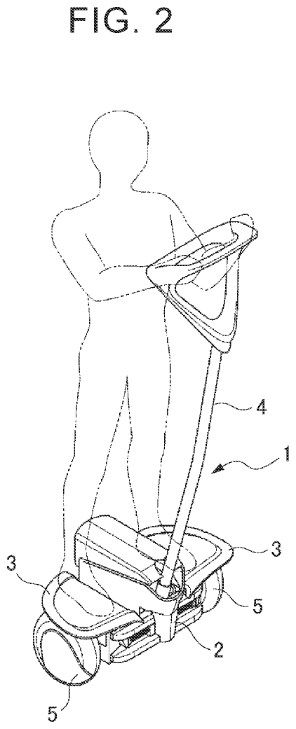

FIG. 2 is a perspective view of a schematic configuration of the movable object 1 according to the embodiment of the disclosure.

The movable object 1 according to the embodiment of the disclosure includes, for example: a vehicle body 2; a right and left pair of steps 3 which is attached to the vehicle body 2 and on which the user rides; an operation handle 4 attached in a tiltable manner to the vehicle body 2 and held by the user; and a right and left pair of drive wheels 5 rotatably attached to the vehicle body 2.

The movable object 1 according to the embodiment of the disclosure is configured as a coaxial two-wheeled vehicle in which the drive wheels 5 are coaxially arranged and which travels while maintaining a inverted state, and is also referred to as a inverted-type movable object. The movable object 1 is configured to move forward or backward when a center of gravity of the user is moved forward or backward to tilt the steps 3 of the vehicle body 2 forward or backward, and to turn to the right or the left when the center of the gravity of the user is moved to the right or the left to tilt the steps 3 of the vehicle body 2 to the right or the left. The coaxial two-wheeled vehicle as described above is applied as the movable object 1. However, the disclosure is not limited thereto and can be applied to any movable object that travels while maintaining the inverted state.

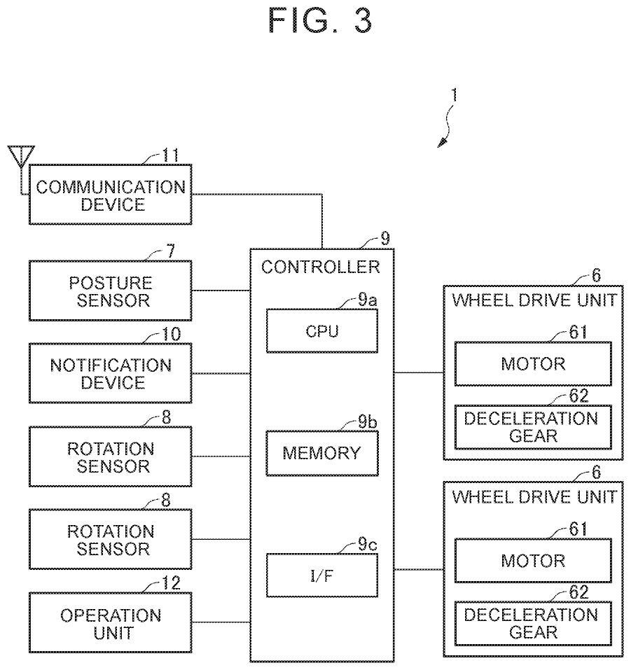

FIG. 3 is a block diagram of a schematic system configuration of the movable object 1 according to the embodiment of the disclosure.

The movable object 1 according to the embodiment of the disclosure includes: a pair of wheel drive units 6 that drives the drive wheels 5; a posture sensor 7 that detects a posture of the vehicle body 2; a pair of rotation sensors 8 that detects rotation information on the drive wheels 5; and a controller 9 that controls each of the wheel drive units 6.

The wheel drive units 6 are installed in the vehicle body 2 and respectively drive the right and left pair of the drive wheels 5. The wheel drive units 6 can rotationally drive the pair of the drive wheels 5 independently. Each of the wheel drive units 6 can be constructed of, for example, a motor 61 and a deceleration gear 62 coupled to a rotational shaft of the motor 61 in a manner to be able to transmit power.

The posture sensor 7 is provided in the vehicle body 2 and detects and outputs posture information on the vehicle body 2, the operation handle 4, and the like. The posture sensor 7 detects the posture information during the travel of the movable object 1 and is constructed of a gyroscope sensor, an acceleration sensor, or the like, for example. When the user tilts the operation handle 4 forward or backward, each of the steps 3 is tilted in the same direction. This posture sensor 7 detects the posture information corresponding to such a tilt. The posture sensor 7 outputs the detected posture information to the controller 9.

The rotation sensors 8 are provided on the drive wheels 5 or the like, respectively, and can each detect the rotation information such as a rotation angle, a rotation angular velocity, rotation angular acceleration, and the like of the corresponding drive wheel 5. Each of the rotation sensors 8 is constructed of a rotary encoder, resolver, or the like, for example. Each of the rotation sensors 8 outputs the detected rotation information to the controller 9.

The controller 9 generates and outputs a control signal used to control driving of each of the wheel drive units 6 on the basis of detection values output from the various sensors mounted on the movable object 1. The controller 9 executes specified arithmetic processing on the basis of the posture information output from the posture sensor 7, the rotation information on the drive wheels 5 output from the rotation sensors 8, and the like, for example, and outputs the necessary control signal to each of the wheel drive units 6. The controller 9 controls each of the wheel drive units 6, so as to execute inverted control in which the inverted state of the movable object 1 is maintained, for example.

The controller 9 has a hardware configuration having, as a central component, a microcomputer that includes: a central processing unit (CPU) 9a that executes control processing, the arithmetic processing, and the like, for example; memory 9b including read only memory (ROM) and random access memory (RAM) in which a control program, an arithmetic program, and the like executed by the CPU 9a are stored; an interface (I/F) 9c that inputs/outputs a signal from/to the outside; and the like. The CPU 9a, the memory 9b, and the interface 9c are mutually connected via a data bus and the like. The programs in this embodiment may be provided in a state of being stored in a computer-readable storage medium. The storage medium can store the programs in a “non-temporary tangible medium”. Examples of the programs are a software program and a computer program.

A notification device 10 is a specific example of notification means. The notification device 10 notifies the user in accordance with a notification signal from the controller 9. The notification device 10 is configured to include, for example, a speaker that outputs sound, a light that turns on/off a warning lamp, a vibrator that vibrates the vehicle body 2, the operation handle 4, or the like, a display that displays a warning; or the like.

A communication device 11 is configured to include a communication circuit that makes communication with the base station BS and the other movable objects 1 by the specified communication standard, and the like. The communication device 11 includes, for example: a transmission circuit that transmits radio waves via an antenna; a reception circuit that receives the radio waves via the antenna; and a switching circuit that switches the circuit to be connected to the antenna between the transmission circuit and the reception circuit.

An operation unit 12 is an interface that is used by the user of the movable object 1 to input information. The operation unit 12 includes an operation button, a touch screen, or the like used by the user for an input operation. When the user operates the operation unit 12, the operation unit 12 supplies a signal corresponding to the operation to the controller 9.

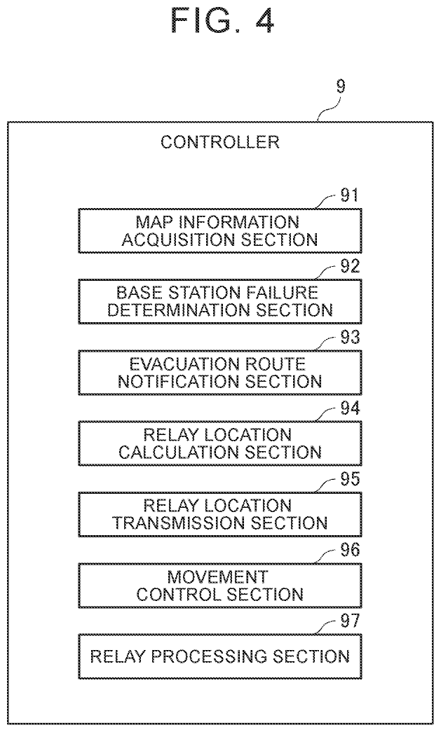

FIG. 4 is a schematic block diagram for illustrating each function module provided in the controller 9 according to the embodiment of the disclosure.

As illustrated in FIG. 4, the controller 9 includes, for example, a map information acquisition section 91, a base station failure determination section 92, an evacuation route notification section 93, a relay location calculation section 94, a relay location transmission section 95, a movement control section 96, and a relay processing section 97.

The map information acquisition section 91 acquires map information from the server S and the like, for example. Such map information may be map information related to the cell C of the specified base station BS. In addition, the map information may include location information of any predetermined evacuation site.

The base station failure determination section 92 detects failure of the base station BS1 on the basis of the control signal that is transmitted/received to/from the base station BS in accordance with the specified wireless communication standard. For example, the base station failure determination section 92 may determine that the base station BS1 has failed in the case where the base station failure determination section 92 cannot receive the specified control signal from the base station BS1 for specified duration. Based on the map information stored in the memory 9b or the like, the evacuation route notification section 93 notifies a location of the evacuation site included in the map information via the notification device 10.

Based on the information on at least one of the movable objects 1 and the map information related to the cell C, the relay location calculation section 94 calculates a specified relay location for wireless communication of at least one of the movable objects 1. Here, the specified relay location is set on a route that connects a first location (for example, an evacuation site E) included in the cell C (a first cell) corresponding to the failed base station BS (a first base station) and a second location included in the cell C (a second cell) corresponding to the other base station BS (a second base station). Furthermore, the specified relay location is set at such intervals that the plural movable objects 1 can make the wireless communication with each other.

The relay location transmission section 95 transmits information on the calculated specified relay location to another movable object 1. In the case of an automated driving mode, for example, the movement control section 96 controls the wheel drive units 6 so as to move the movable object 1 to a specified destination. For example, in a state where the movable object 1 is arranged at the specified relay location, the relay processing section 97 relays a signal that is exchanged between the wireless communication terminal M and another base station BS.

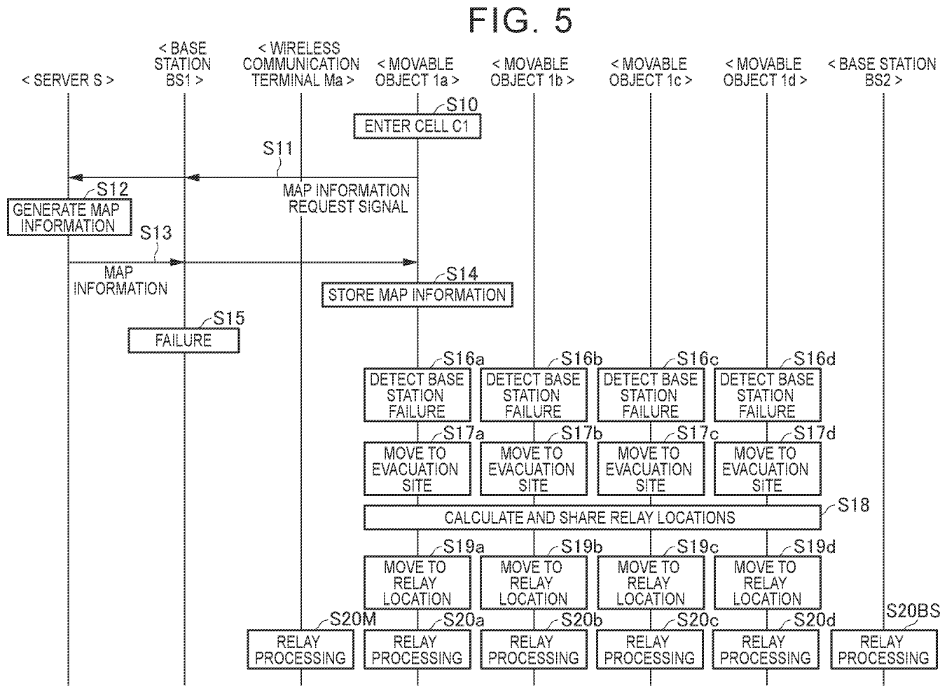

FIG. 5 is a chart of an example of an operation sequence in relay processing that is executed by the wireless communication system 100 according to the embodiment of the disclosure. Hereinafter, a description will be made on an example of a case where the four movable objects 1a, 1b, 1c, 1d are operated. However, the number of the movable objects 1 is not limited thereto and may be any number.

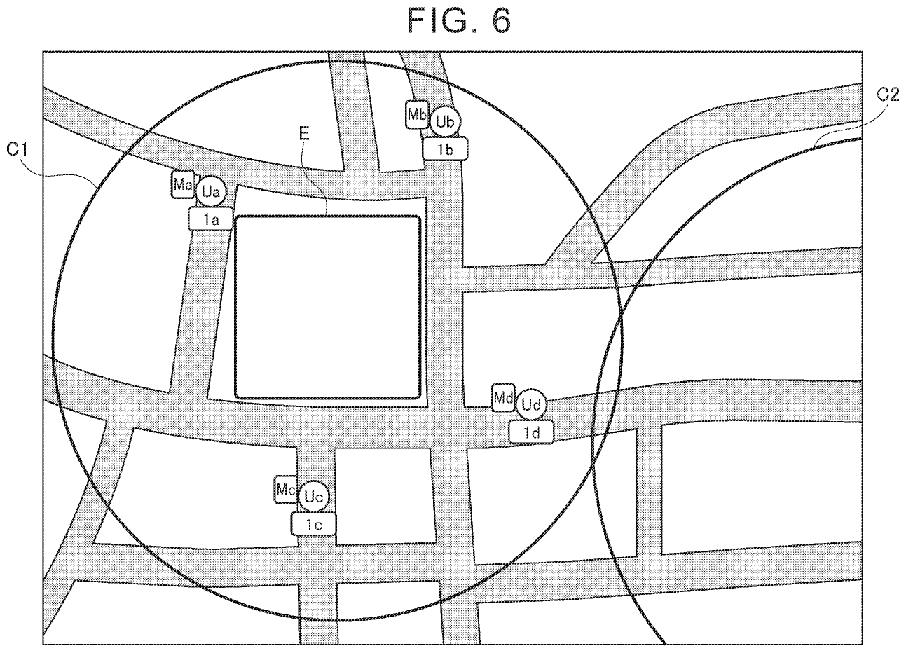

First, the movable object 1a enters the cell C1 of the base station BS1 by the user's driving operation or the automated driving, for example (S10). While being in the cell C1, the movable object 1a exchanges the specified control signal with the base station BS1 intermittently in accordance with the specified wireless communication standard. Similarly, it is assumed that the other movable objects 1b, 1c, 1d also enter the cell C1. As it has been described so far, as illustrated in FIG. 6, for example, the movable objects 1a to 1d are arranged in the cell C1.

Next, when the movable object 1a enters the cell C1, the map information acquisition section 91 transmits a map information request signal, which indicates a request for the map information of the cell C1 of the base station BS1, to the server S via the base station BS1 (S11). The map information is map information related to at least part of the region included in the cell C1. In addition, the map information may include the location information of at least one of the predetermined evacuation sites, for example.

Next, when acquiring the map information request signal, the server S generates the requested map information of the cell C1 from a storage unit provided in the server S itself, another database, or the like, for example (S12). Then, the server S transmits the generated map information of the cell C1 to the movable object 1a (S13). Next, when acquiring the map information from the server S, the map information acquisition section 91 in the movable object 1a stores the acquired map information in the memory 9b (S14). What have been described so far in S10 to 14 are also executed for the other movable objects 1b, 1c, 1d.

Here, it is assumed that the base station BS1 fails due to a disaster such as an earthquake, and, as a result, the base station BS1 can no longer make the wireless communication with the wireless communication terminals M in the cell C1 (S15). Thus, the base station failure determination section 92 in the movable object 1a detects the failure of the base station BS1 (S16a to 16d). More specifically, the base station failure determination section 92 detects the failure of the base station BS1 on the basis of the control signal that is exchanged between the base station BS1 and the movable object 1a in accordance with the wireless communication standard. For example, the base station failure determination section 92 determines that the base station BS1 has failed in the case where the base station failure determination section 92 cannot receive the specified control signal from the base station BS1 for the specified duration. Similar processing is also executed for the movable objects 1b to 1d.

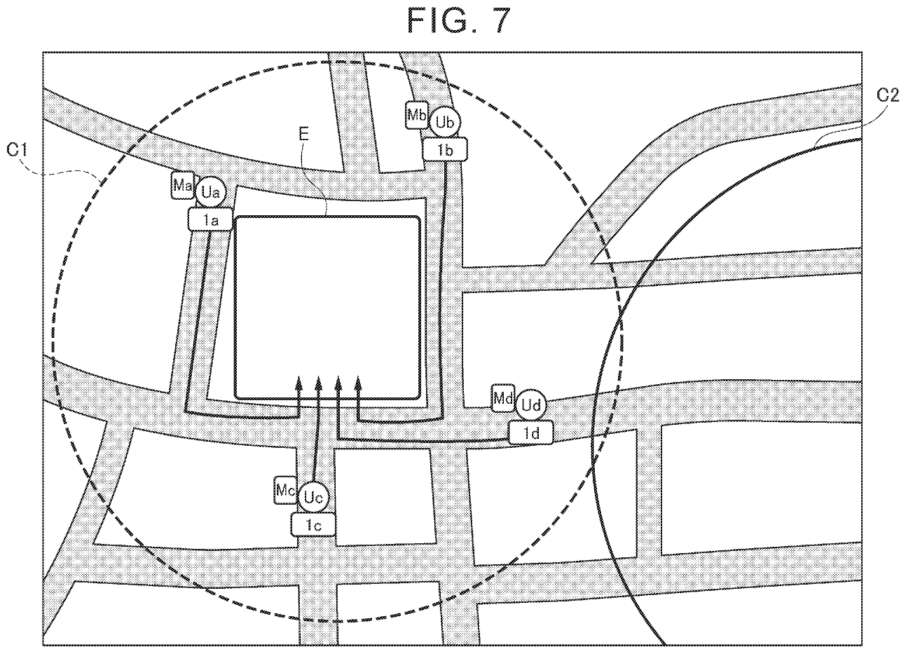

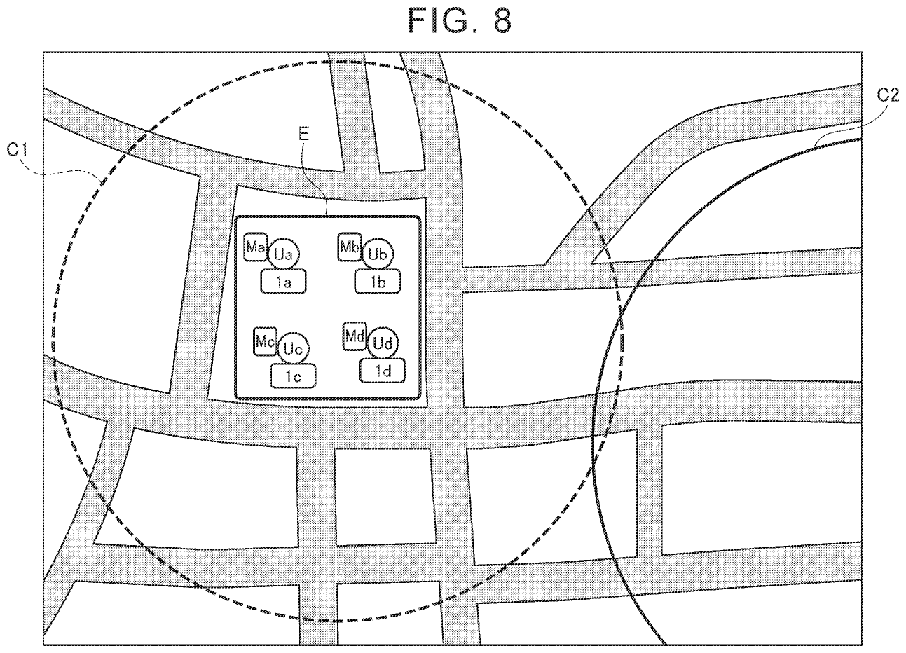

Next, for example, as illustrated in FIG. 7, the movable object 1a moves to the evacuation site E by the user's driving operation or the automated driving (S17a to 17d). In the case of the user's driving operation, based on the map information of the cell C1, which is stored in the memory 9b, the evacuation route notification section 93 notifies the user of the location information of the evacuation site E via the notification device 10. Although a mode of the notification is not particularly limited, a screen in such a mode that the location of the evacuation site E can be comprehended may appear on the display, for example. Alternatively, the speaker may output sound that provides the information on the evacuation site E such as a name and an address. Then, the user drives the movable object 1a to move to the evacuation site E in accordance with the location information of the evacuation site E notified by the notification device 10. Meanwhile, in the case of the automated driving, the movement control section 96 controls the wheel drive units 6 on the basis of the location information of the evacuation site E, which is included in the map information of the cell C1 stored in the memory 9b, so as to cause the movement of the movable object 1a to the evacuation site E. Similar processing to the processing described so far is also executed for the movable objects 1b to 1d. For example, as illustrated in FIG. 8, the movable objects 1a to 1d and the users Ua to Ud gather at the evacuation site E.

Next, the at least one movable object 1 of the movable objects 1a to 1d that have gathered at the evacuation site E accepts input of information on the movable objects 1a to 1d that have gathered at the evacuation site E by the operation of the single user (Ua, Ub, Uc, Ud, or the like) or another person (S18). Such information may be the number of the movable objects 1a to 1d that have gathered at the evacuation site E (four in this case) or identification information or another type of information on these movable objects 1a to 1d, for example. Then, the relay location calculation section 94 in the movable object 1 that has accepted the input of such information calculates the relay location of each of the movable objects 1a to 1d on the basis of the information on the movable objects 1a to 1d and the map information of the cell C1. Then, the relay location transmission section 95 in the movable object 1 that has calculated the relay locations transmits information on the calculated relay locations to the other movable objects 1. In this way, each of the gathered movable objects 1a to 1d can comprehend the relay location of itself.

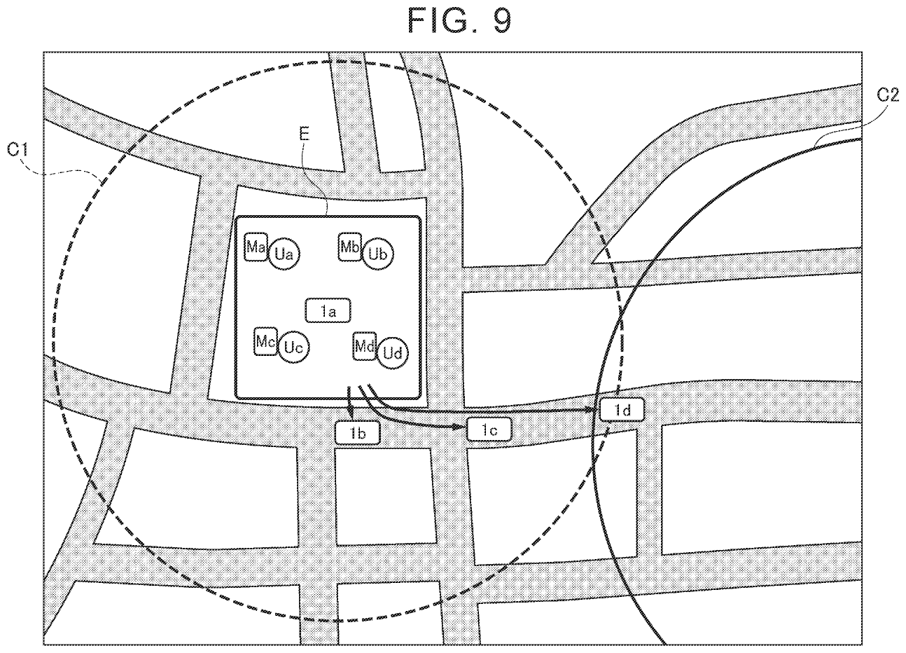

Next, for example, as illustrated in FIG. 9, the movable objects 1a to 1d move to the relay locations of themselves (S19a to 19d). As illustrated in FIG. 9, the movable object 1d moves to a specified location (the second location) within the cell C2 (the second cell) of the base station BS2 (the second base station). Since the base station BS2 does not fail, at the second location, the movable object 1d can make the wireless communication with the base station BS2.

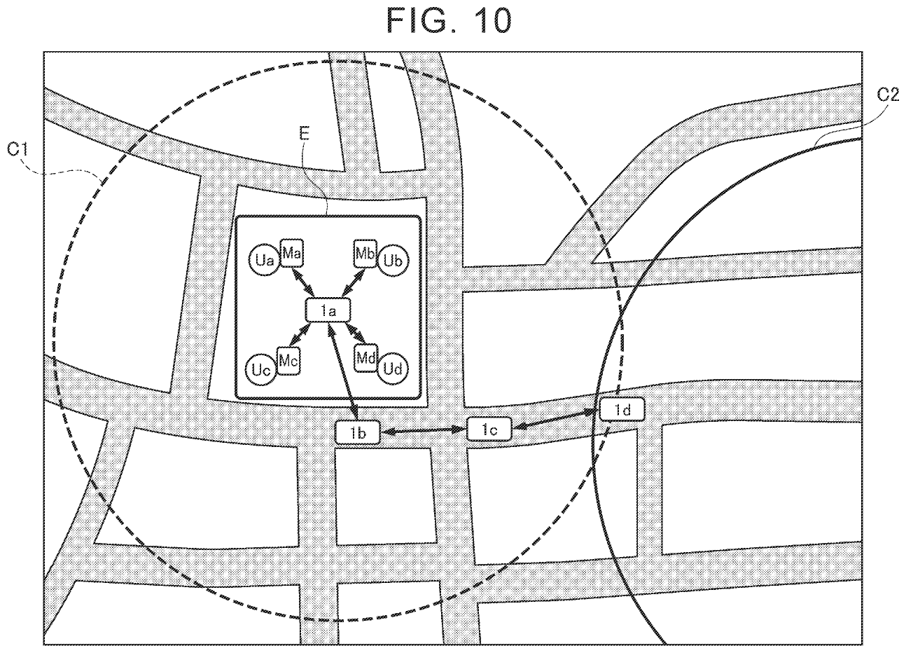

Next, for example, as illustrated in FIG. 10, each of the movable objects 1a to 1d relays the wireless communication at the specified relay location (S20a to 20d, 20M, 20BS). More specifically, the movable object 1d relays the wireless communication between the base station BS2 and the movable object 1c (S20d). The movable object 1c relays the wireless communication between the movable object 1d and the movable object 1b (S20c). The movable object 1a relays the wireless communication between each of the wireless communication terminals M and the movable object 1b (S20a). Note that FIG. 5 illustrates, as one example, the wireless communication terminal Ma, which is used by the user Ua; however, the wireless communication terminal M may be any of the wireless communication terminals Mb, Mc, Md used by the other users Ub, Uc, Ud, respectively. As it has been described so far, each of the wireless communication terminals M at the evacuation site E can make the wireless communication with the base station BS2 via the movable objects 1a to 1d.

The embodiment that has been described so far is merely provided to facilitate understanding of the disclosure, and thus is not provided to limit interpretation of the disclosure. Each of the elements included in the embodiment as well as arrangement, a material, a condition, a shape, size, and the like thereof is not limited to what has been exemplified above and can appropriately be changed. In addition, the components described in the different embodiments can partially be replaced or combined.

What is claimed is:

1. A movable object including a drive unit and a communication device, the movable object comprising:
a determination section that determines failure of a base station via the communication device;
a movement control section that drives the drive unit to cause movement of the movable object to a specified relay location on a route connecting a first location included in a first cell of a first base station and a second location included in a second cell of a second base station; and
a relay processing section that relays a signal at the specified relay location, the signal being exchanged between a wireless communication terminal located in the first cell and the second base station.

2. The movable object according to claim 1 further comprising:
a relay location calculation section that calculates the specified relay location of the at least one movable object on the basis of information on the at least one movable object located in the first cell and map information related to the first cell; and
a relay location transmission section that transmits the specified relay location calculated by the relay location calculation section to the at least one movable object.

3. The movable object according to claim 2 further comprising
a map information acquisition section that acquires the map information related to the first cell.

4. The movable object according to claim 3, wherein
the map information acquisition section acquires the map information at least when the movable object enters the first cell.

5. The movable object according to claim 2, wherein
the map information includes location information of at least one evacuation site.
